(19) United States
(12) Patent Application Publication
(10) Pub. No.: US 2019/0392587 A1
(43) Pub. Date: Dec. 26, 2019

(54) SYSTEM FOR PREDICTING ARTICULATED OBJECT FEATURE LOCATION

(71) Applicant: Microsoft Technology Licensing, LLC, Redmond, WA (US)

(72) Inventors: Sebastian NOWOZIN, Cambridge (GB); Federica BOGO, Cambridge (GB); Jamie Daniel Joseph SHOTTON, Cambridge (GB); Jan STUEHMER, Cambridge (GB)

(21) Appl. No.: 16/100,179

(22) Filed: Aug. 9, 2018

(30) Foreign Application Priority Data
Jun. 22, 2018 (GB) 1810309.3

(51) Int. Cl. G06T 7/246; G06F 15/18; G06N 3/08; G06N 7/00

(52) U.S. Cl. CPC G06T 7/246; G06F 15/18; G06T 2207/20081; G06N 7/005; G06T 2207/30196; G06N 3/08

(57) ABSTRACT

A system to predict a location of a feature point of an articulated object from a plurality of data points relating to the articulated object of which some possess and some are missing 2D location data. The data points are input into a machine learning model that is trained to predict 2D location data for each feature point of the articulated object that was missing location data.

### BACKGROUND

Extracting information about an object appearing in an image or in a frame of a video provides a way to extract valuable data from the image or video. Feature detection methods enable not only the detection of objects in an image or in a frame, for example a human body, but also the detection of specific features of the object. For example, the detection and identification of specific body features in an image or video frame, such as the head, neck, shoulder, elbows, hands or other body features. Feature detection can be computationally expensive so often a higher level algorithm is used to identify certain parts of an image that are likely to contain relevant features and only the identified parts of the image are processed during a feature detection stage.

Identifying body parts can provide valuable data from an image, but the value of the information can be further increased by tracking the respective body parts over time to provide information about the motion of the body parts and therefore the movements of a related body. However, if part of a body to be detected is partially obscured by another part of the body (self-occlusion) or by an additional object, or because the person is partially outside a field of view of a camera, then feature detection can fail and, consequentially, additional computation that relies on the feature detection can fail.

A mathematical model of an object can be used to predict a location of part of the object obscured from view, but previous approaches to predicting location information of obscured features are often both computationally demanding meaning that they are unsuitable for real-time use and the predicted locations of the obscured features can be erratic or unrealistic.

The embodiments described below are not limited to implementations which solve any or all of the disadvantages of known systems that predict the location of features of an articulated object.

### SUMMARY

The following presents a simplified summary of the disclosure in order to provide a basic understanding to the reader. This summary is not intended to identify key features or essential features of the claimed subject matter nor is it intended to be used to limit the scope of the claimed subject-matter. Its sole purpose is to present a selection of concepts disclosed herein in a simplified form as a prelude to the more detailed description that is presented later.

A system to predict a location of a feature point of an articulated object from a plurality of data points relating to the articulated object of which some possess and some are missing 2D location data. The data points are input into a machine learning model that is trained to predict 2D location data for each feature point of the articulated object that was missing location data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1a is a representation of a partially obscured body;

FIG. 1b illustrates feature points of the body in FIG. 1a;

FIG. 2 is a flow diagram of a method to predict two-dimensional location data for a feature point missing from a set of two-dimensional points;

FIG. 3a, FIG. 3b and FIG. 3c are arrays of data relating to blocks of FIG. 2;

FIG. 4 is a flow diagram of a method to train a machine learning model for use in the flow diagram of FIG. 2;

FIG. 5 is a flow diagram of a method to predict a third-dimension for a set of two-dimensional points;

FIG. 6 is an array of data relating to the method of FIG. 5;

FIG. 7 is a flow diagram of a method to train a machine learning model for use in the flow diagram of FIG. 5;

FIG. 8a is flow diagram of a method according to a first generic machine learning model;

FIG. 8b is a flow diagram of a method according to a second generic machine learning model;

FIG. 9 illustrates the feature points of the body in FIG. 1a after having a depth value predicted; and

FIG. 10 illustrates an exemplary computing-based device in which embodiments of the systems and methods described herein are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Although the present examples are described and illustrated herein as being implemented in a feature point location system, the system described is provided as an example and not a limitation. As those skilled in the art will appreciate, the present examples are suitable for application in a variety of different types of feature point location systems to predict a location of a feature point of an articulated object.

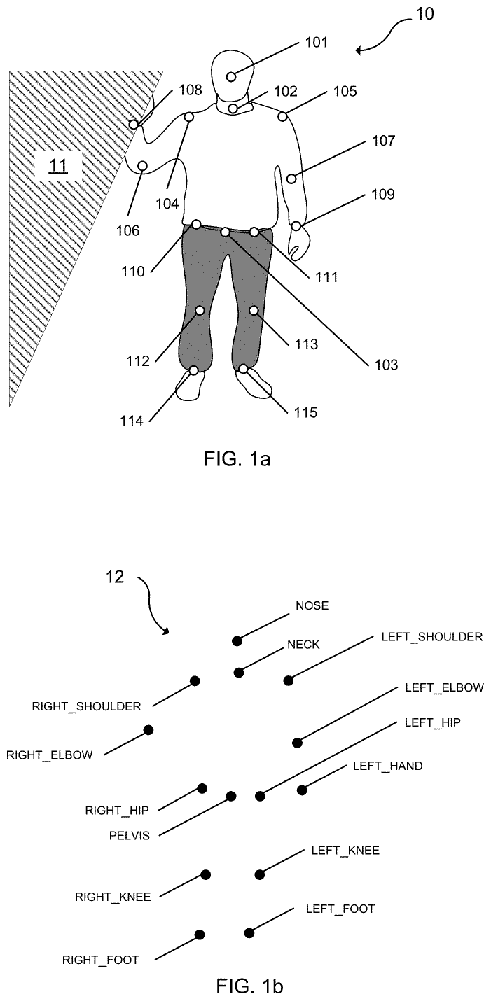

FIG. 1a is a representation of a body 10 partially obscured by an object 11. Specifically, the right hand of the body 10 is obscured, while the rest of the feature on the front of the body are visible. The image of the partially obscured body 10 can be processed by know systems to identify and tag features of the body 10. The identified features 101-115 of the body 10 are represented by white dots in FIG. 1a. The identified features are the: nose 101, neck 102, pelvis 103, right shoulder 104, left shoulder 105, right elbow 106, left elbow 107, left hand 109, right hip 110, left hip 111, right knee 112, left knee 113, right foot 114 and left foot 115. The right hand 108 is identified in FIG. 1a for illustrative purposes, however, a feature detection algorithm would not detect a right hand 108 due to it being obscured by the object 11. Here a second object is obscuring a feature of a first object, however, the first object could also be self-obscured or partially outside a boundary of the image.

A non-exhaustive list of examples of suitable known systems for identifying and tagging features is: a trained classifier that labels image elements as being one of a plurality of possible features, a trained random decision forest that labels image elements as being one of a plurality of possible features, a classifier that uses depth camera data depicting an articulated object to compute 2D feature positions of the articulated object for a plurality of specified feature points.

The identified visible feature points are shown in FIG. 1a, represented by white circles, and shown in FIG. 1b, represented by black circles. In FIG. 1b, the right hand feature point 108 is excluded as it was not visible and therefore not identifiable in FIG. 1a. The identified feature points are labelled in FIG. 1b, e.g. feature point 101 in FIG. 1a was identified as a feature point corresponding to a nose, so was labelled accordingly in FIG. 1b. These identification and labelling steps are often automated and the result is a plurality of feature points and their corresponding location in either two dimensions if the image or video was taken by a RGB camera, or in three dimensions if the image or video was taken by a device with a RGB camera and a depth sensor, for example a Microsoft Kinect™ device or another type of three dimensional image sensing device. Three dimensional image data can be used for training a machine learning model as discussed below.

If lines representing a skeleton were drawn between the points in FIG. 1b, then the skeleton would not be complete as there is no location for the right hand feature point 108. It would be possible to randomly assign a location for the right hand feature point 108, but this would likely be in an incorrect position. If a previous position of the right hand 108 is known (from previous images or previous frames of a video), then it would be possible to predict a current location from the previous information, but that predicted location would not change even if the position of the right elbow 106 changed in subsequent images/frames while the right hand 108 remained obscured. Another associated problem with a feature point prediction algorithm relying on past observed locations of one or more presently undetected feature points occurs when there are one or more undetected feature points in an image/frame and there is no previous observed location to be used as an input into a feature point prediction algorithm. Such a scenario may occur when an articulated object first enters a frame, for example when a person enters a room, but part of the body remains not visible to a camera field of view. A human body is a common articulated object subject to feature point detection and will mostly be used in this document for consistency and conciseness, but the methods and systems described in this document equally relate to an animal body or parts of a human body, for example a human hand could be the subject of feature extraction with individual fingers or joints thereof being the features to be identified. Further, other articulated objects, for example cars or machinery, may be objects suitable for feature detection.

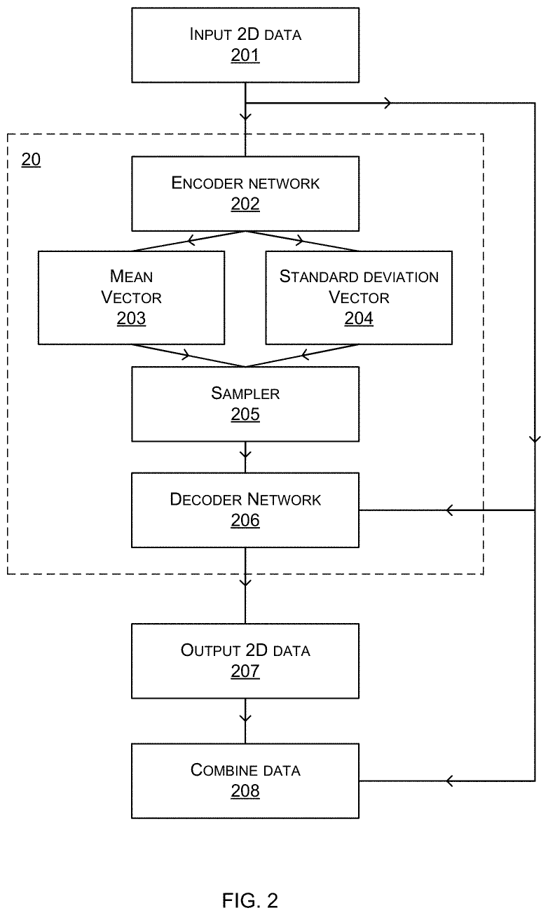

FIG. 2 is a flow diagram of a method performed by a type of deep generative model called a conditional variational autoencoder 20. A conditional variational autoencoder functions differently to a standard variational autoencoder. For a conditional variational autoencoder, a prediction, e.g. of a 2D location, y, is not only conditioned on a latent variable, e.g. z, but also on the input, e.g. x. For a prediction of a location, y: a standard variational autoencoder only indirectly depends on x through z, i.e. y˜p(y|z) with z˜p(z|x) while a conditional variational autoencoder directly depends on x, i.e. y˜p(y|x, z) with z˜p(z|x).

The conditional variational autoencoder 20 of FIG. 2 comprises a pair of connected networks, an encoder network 202 and a decoder network 206, which are trained neural networks. The encoder network 202 takes input data 201, and compresses it into a smaller, dense representation. The conditional variational autoencoder 20 encoding outputs two vectors: a vector of mean 203 and a vector of standard deviation 204. The sampler 205 is able to draw multiple samples, a single sample or a mean as a single sample from the mean vector 203 and the standard deviation vector 204. The decoder network 206 receives the input 2D data and also the output of the sampler 205. Each of the samples is then decoded, or decompressed, by the decoder network 206 before being outputted 207 from the conditional variational autoencoder 20.

The conditional variational autoencoder 20 of FIG. 2 is arranged to receive a plurality of 2D coordinates of feature points, for example of a body, hand, mechanical device, etc., and an encoding of their visibility and predict 2D coordinates of any non-visible feature points of the object. The blocks of FIG. 2 and their function are discussed below.

The Input 2D Data block represents the input into the encoder 20, which is an indexed set of 2D image coordinates x={xⁱ∈ [symbol] 2} and an encoding ν={νⁱ∈{0,1}} of their visibility, with a ‘1’ for each detected feature point and a ‘0’ for each undetected feature point (xⁱ=0 is set for each νⁱ=0). The visibility encoding may be a Boolean value or data type, or other data type.

The Output 2D data block 207 represents the output of the conditional variational autoencoder 20 where the 2D coordinates of undetected (or occluded) feature points y={yⁱ ∈ [symbol] } are predicted.

The conditional variational autoencoder 20 uses a multivariate Normal distributed latent variable z, i.e. p (z)= [symbol] (0, 1). The conditional distribution of y gives the 2D coordinates x as an infinite mixture of Gaussians,

p(y|x,v)=∫p_{θ}(y|z,x,v)p(z)dz (1)

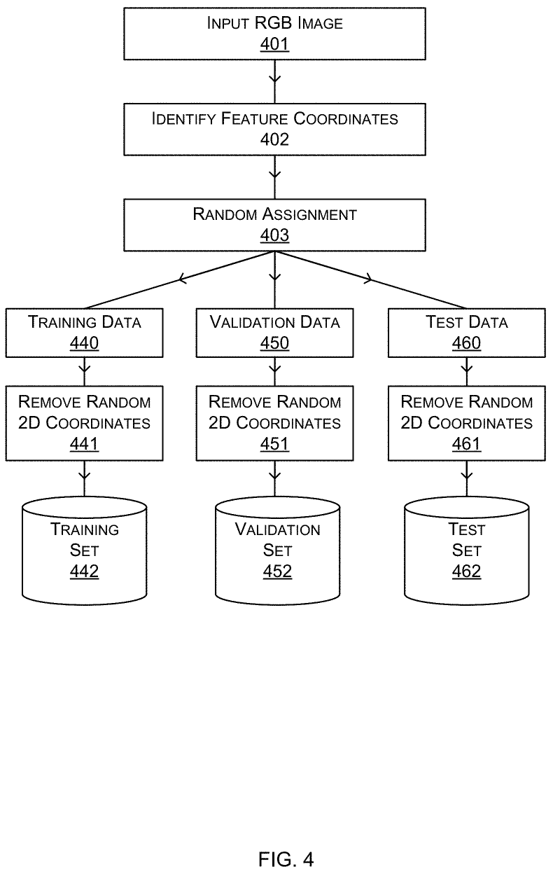

at blocks 203 and 204. The conditional distribution p_{θ}(y|z, x, v) is a deep learning model with parameter θ, which is learned from a training data set described in FIG. 4. In a framework of the conditional variational autoencoder 20, the deep learning model of the decoder network 206 is denoted as p_{θ}(y|z, x, v) and p_{ψ}(z|x, v). The deep learning model of the encoder network 202 is denoted as p_{ψ}(z|x, v) with parameter ϕ. The parameters θ, ψ and ϕ are optimized to maximize the evidence lower bound of the convolutional variational autoencoder, ELBO_{CVAE}:

$${ELBO}_{CVAE} = - {D}_{KL} ( {q}_{φ} ( z \vert x , υ , y ) \vert \vert {p}_{ψ} ( z \vert x , υ ) ) + \frac{1}{L} {\sum }_{i}^{L} log {p}_{θ} ( y \vert x , υ , {z}^{( l )} ) , \qquad ( 2 )$$

where, at Sampler block 205, each z^{l} is sampled from z^{l}˜q_{ϕ}(z|x, v, y) and the number of samples L.

The Output 2D Data block 207 represents a location for predicted 2D coordinates of non-visible feature points, and these are combined with the 2D image coordinates of the visible feature points at Combine Data block 208. The non-visible feature points in x are replaced by the predicted coordinates from y by computing the element-wise product with the visibility encoding:

\tilde{x}=v∘x+(1−v)∘y. (3)

Above is described sampling L samples from the latent variables at the Sampler block 205. Alternatively, the mean of the latent distribution, from Mean Vector block 203, is taken as a single sample 205 and used to predict the 2D location data for the non-visible feature points without use of the standard deviation vector 204.

In some cases, only a partial set of all feature points are observed. This could be due to occlusions or due to a failure of a feature detection system. In such a case, the visibility mask, v, encodes which feature points of an object are detected and which are not detected. Through the use of the visibility mask at the combine data block 208, the conditional variational autoencoder 20 will predict locations of the features which are not detected and combine them with the locations of the features that are detected in a single data set.

The sampler 205 is able to draw L samples, which may include (i) multiple samples sample of latent variables from the mean vector 203 and the standard deviation vector 204, e.g. two, four, eight, sixteen or thirty-two samples (ii) a single sample of the latent variables from the mean vector 203 and the standard deviation vector 204 or (iii) a single sample of the mean vector 203 latent variable. Taking multiple samples of predicted 2D locations for a feature point of an articulated object enables each of the samples for the predicted location to be further processed using additional model, which increases the likelihood that one sampled predicted 2D feature point location will likely be correct and the additional model will therefore likely be able to successfully make an accurate prediction based on the most accurate predicted 2D feature location position.

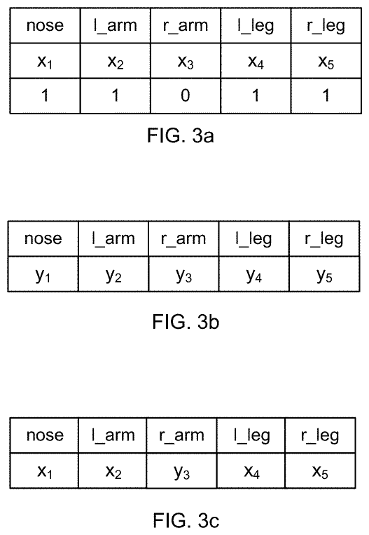

FIG. 3a illustrates an exemplary input presented at Input 2D Data block 201, whereby the first row are feature identifiers for the feature points in an image pre-processed to extract visible feature information. The pre-processing was to detect five feature points in the image: nose, l_arm, r_arm, l_leg and r_leg. The labels are not essential as the order of the feature points can indicate the respective feature. The second row is a set of 2D image coordinates x and the third row is a set of visibility encodings v each corresponding to the above coordinates, whereby a visibility encoding of 1 indicates the associated feature point was detected and a visibility encoding of 0 indicates the associated feature point was not detected. From the exemplary input data in FIG. 3a, it is discernable that the nose, l_arm, l_leg and r_leg feature points were detected, but the r_arm feature point was not detected as denoted by the corresponding visibility encoding of 0 in the third row, middle column.

FIG. 3b illustrates an exemplary output presented at Output 2D Data block 207, for the input illustrated in FIG. 3a. The conditional variational autoencoder 20 predicted 2D location data of y₃ for the r_arm feature point.

FIG. 3c illustrates the result of the Combine Data block 208 whereby the predicted 2D location data presented at Output 2D Data block 207 is combined with the input presented at Input 2D Data block 201 illustrated in FIG. 3a and the 2D location data predicted by the conditional variational autoencoder 20 replaces the r_arm feature point 2D location data input presented at Input 2D Data block 201.

FIG. 4 illustrates a method for training of the conditional variational autoencoder 20 to predict feature point locations of bodies. A RGB video stream of a population of different people performing a set of articulated object arrangements in front of a camera is recorded. The detected set of feature points of each person is assigned to one of the training data 440, validation data 450 or test data 460, which are subsequently used to train the parameters θ, ψ and ϕ by maximizing the evidence lower bound objective function. The data in each set is augmented by removing 2D coordinates of some of the feature points at random 441, 451, 461. Optionally, each data set 442, 452, 462 can be further augmenting by applying a rigid body transformation to the recorded articulated object arrangements and the addition of noise, thus generating views of the articulated object arrangements from different angles and locations thereby increasing the size of the training set 442, validation set, 452 and test set 462.

The training objective for the conditional variational autoencoder 20 model is ELBO_{CVAE} of Equation 2. Deep learning optimizers suitable for the machine learning task include stochastic gradient descent, adam and smorms3. The training set 442 is used to obtain estimates for the parameters \tilde{θ}, \tilde{ψ} and \tilde{ϕ} of the conditional variational autoencoder 20. Training may be performed for several iterations of the optimizer through the training set 442, known as “epochs” to produce a plurality of alternative models. Each of the plurality of alternative models may then be evaluated using the validation set 452. The validation accuracy is used to choose between multiple alternative models, for example, the alternative models will vary as a result of choices, for example due to varying a number of layers in a neural network. To assess the accuracy of the conditional variational autoencoder 20, a separate validation and test step are further employed. The model with the greatest accuracy after being tested on the validation set 452 is selected and verified on the test set 462 to obtain a final performance estimate.

The random assignment 403 of the data into training data 440, validation data 450 test data 460 on a “per person” rather than a “per frame” basis (i.e. all the frames captured for a particular person are applied to a single data set) ensures that a machine learning model trained on the data is able to generalized over different people.

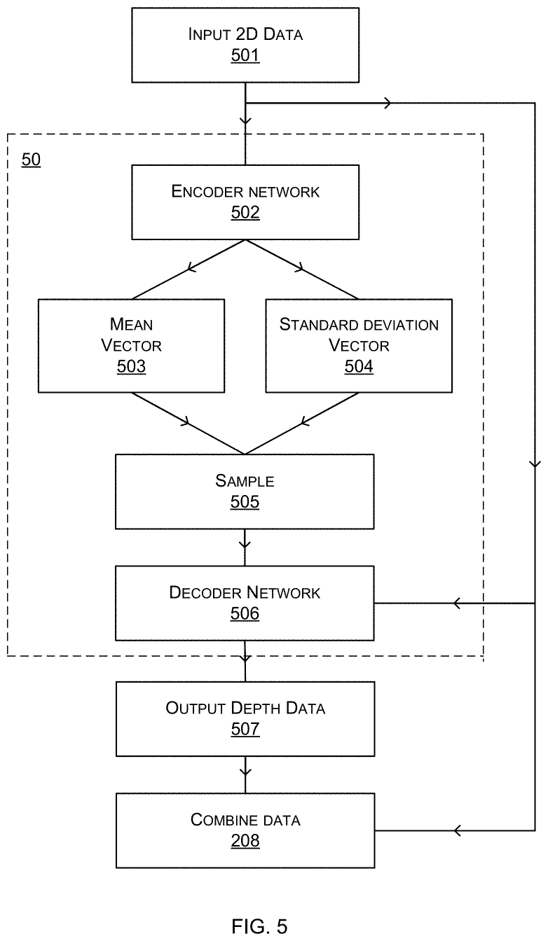

FIG. 5 is a flow diagram of a method to predict third-dimension data, i.e. depth data d, for each of a set of two-dimensional feature points of an object using a second conditional variational autoencoder 50.

A set of 2D coordinates corresponding to feature points of an object is received by the second conditional variational autoencoder 50 at the Input 2D Data block 501. Optionally, the received set of 2D coordinates is from a first machine learning model, such as the first conditional variational autoencoder 20 where the Input 2D Data block 501 has input the result of the Combine Data block 208, illustrated in FIG. 3c.

Using a multivariate Normal distributed latent variable w, i.e. p(w)= [symbol] (0, 1), the conditional distribution of d, given the 2D coordinates \tilde{x}, is an infinite mixture of Gaussians,

p(d|\tilde{x})=∫p_{\tilde{θ}}(d|w,\tilde{x})p(w)dw. (4)

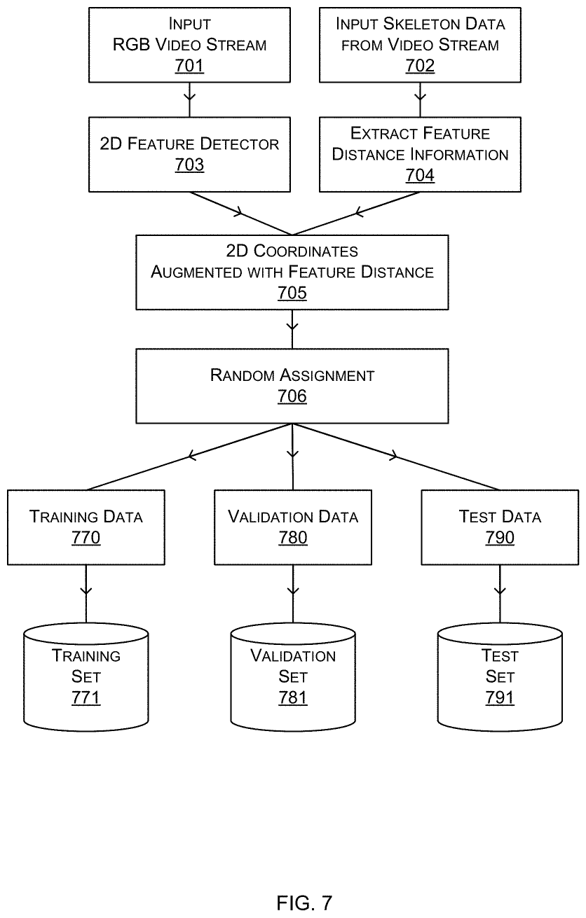

The conditional distribution p_{\tilde{θ}}(d|w,\tilde{x}) is a deep learning model with parameter \tilde{θ}, learned from a training data set. Further details about the training data set for the second conditional variational autoencoder 50 is described in relation for FIG. 7. In the conditional variational autoencoder 50 framework, the decoder network 506 deep learning models are defined as p_{\tilde{θ}}(d|w,\tilde{x}) and p_{\tilde{ψ}}(d|w,\tilde{x}), and the Encoder Network deep learning model is defined as q_{\tilde{ϕ}}(w|\tilde{x},d) with a deep learning model with parameter \tilde{ϕ}. The parameters \tilde{θ}, \tilde{ψ} and \tilde{ϕ} are optimized to maximize the evidence lower bound of the convolutional variational autoencoder, [symbol] _{CVAE}:

$${CVAE}_{} = - {D}_{KL} ( {q}_{\tilde{φ}} ( w \vert \tilde{x} , d ) \vert \vert {p}_{\tilde{ψ}} ( w \vert \tilde{x} ) ) + \frac{1}{\tilde{L}} {\sum }_{i}^{\tilde{L}} log {p}_{\tilde{θ}} ( d \vert \tilde{x} , {w}^{( l )} ) , \qquad ( 5 )$$

where at Sample 505 each w^{l} is sampled from w^{l}˜q_{\tilde{ϕ}}(w|\tilde{x},d) and the number of samples \tilde{L}.

The conditional variational autoencoder 50 can predict articulated object arrangements from the model by sampling. The sampler 505 is able to draw L samples, which may include (i) multiple samples sample of latent variables from the mean vector 503 and the standard deviation vector 504, e.g. two, four, eight, sixteen or thirty two samples (ii) a single sample of the latent variables from the mean vector 503 and the standard deviation vector 504 or (iii) a single sample of the mean vector 503 latent variable. The decoder network 206 receives the input 2D data and also the output of the sampler 505.

The models of FIG. 2 and FIG. 5 may be combined. In such an arrangement, first, a latent z˜p(z|x,v) for given 2D feature point coordinates x and visibilities v is sampled. The latent z is used in y˜p_{θ}(y|x,v,z) and replaces the coordinates of missing feature points in x as described in Equation 3. The sample of \tilde{x} is then used to sample a latent w˜p(w|\tilde{x}). Finally, p_{\tilde{θ}}(d|\tilde{x},w) is sampled to provide a set of distance values for each feature point, which are provided at Output Depth block 507. Generating several samples from the model allows the uncertainty over the posterior of possible 3D articulated object arrangements to be quantified. A benefit of this model is that every sample is a complete 3D articulated object arrangement, rather than a set of independent feature coordinates. By combining the models of FIG. 2 and FIG. 5, the second conditional variational autoencoder 50 can receive multiple latent variables from the first conditional variational autoencoder 20. For example, if the sampler 205 from the first conditional variational autoencoder 20 draws eight samples of a predicted feature point 2D location, each of the eight samples is processed by the second conditional variational autoencoder 50 and the sampler 505 of the second conditional variational autoencoder 50 may also draw eight samples for each of the eight input samples, meaning the sampler 505 outputs a total of sixty-four samples for the predicted depth locations. The number of samples drawn by each conditional variational autoencoder may be altered depending upon the accuracy of data received and the processing power available.

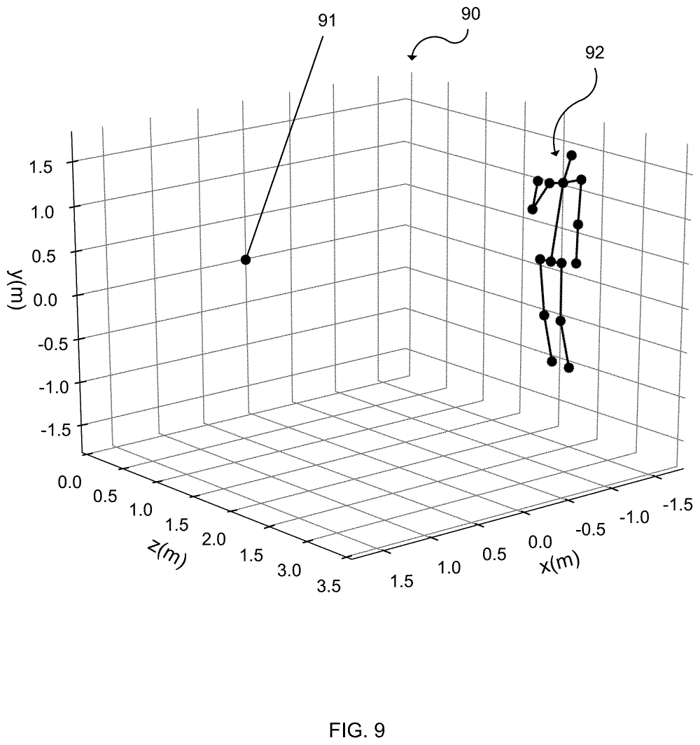

With the known intrinsic parameters of a camera used to take an original 2D image (i.e. the camera has been calibrated for focus length and distortion, etc.), a full 3D articulated object arrangement can be derived by back-projecting the 2D coordinates, x, using the distance values, d. A back-projected 3D articulated object arrangement is illustrated in FIG. 9, described later. The Combine Data 508 block of FIG. 5 illustrates that the predicted depth data for each feature point from Output Depth Data 507 may be combined with its respective 2D feature point to provide a predicted 3D feature point location.

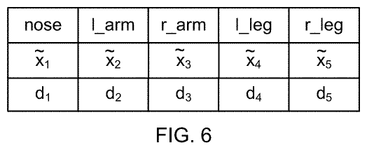

As stated above, the exemplary output data (illustrated in FIG. 3c) of the method illustrated in FIG. 2 can be input into the second autoencoder 50 at Input 2D Data 501 block and the Combine Depth Data block 507 receives the information exemplified in FIG. 6, comprising the 2D locations and corresponding depth information that, when combined, provides 3D coordinates for each feature point of the object.

FIG. 7 is a flow diagram of a method for training a machine learning model for use in the flow diagram of FIG. 6. Initial video data is collected from a video stream of a camera that can collect both RGB and depth information. A Microsoft Kinect™ device or similar may be used as it provides a RGB video stream and Skeleton Data associated with objects identified in the video stream. The camera should be exposed to a population of different articulated objects, e.g. people, moving within its field of view. The RGB and skeleton data is input into the Input RGB Video Stream block 701 and the Input Skeleton Data from Video Stream block 702. The RGB data is fed into a 2D feature detector 703, which identifies the 2D coordinates of features identified in the RGB data, and skeleton data is fed into Extract Feature Distance Information block 704, which extracts distance information from predetermined feature points of the skeletons. The 2D feature coordinates are augmented with their respective distance from camera information 705 and randomly assigned 706 to one of training data 770, validation data 780 or test data 790. The data 770, 780, 790 is stored in a training set 771, validation set 781 or test set 791, which are subsequently used to train, test and validate the parameters \tilde{θ}, \tilde{ψ} and \tilde{ϕ}.

Optionally, the training set 771, validation set 781 and test set 791 is further augmented by applying a rigid body transformation to the recorded articulated object arrangements, thereby generating additional articulated object arrangements using the existing articulated object arrangements at different angles and locations.

The training objective is the [symbol] _{CVAE} of Equation 5. Deep learning optimizers suitable for the machine learning task include stochastic gradient descent, adam and smorms3. The training set 770 is used to obtain estimates for the parameters \tilde{θ}, \tilde{ψ} and \tilde{ϕ} of the conditional variational autoencoder 20. Training can be performed for several iterations of the optimizer through the training set 770, known as “epochs” to produce a plurality of alternative models. Each of the plurality of alternative models is then evaluated using the validation set 781. A validation accuracy is used to choose between multiple alternative models, for example, the alternative models by vary resulting from a change in a number of layers in a neural network. To assess the accuracy of the conditional variational autoencoder 50, a separate validation and test step are employed. The model with the greatest accuracy after being tested on the validation set 781 is selected and verified on the test set 791 to obtain a performance estimate.

The random assignment 706 of the data into training data 770, validation data 780 and test data 790 on a “per person” rather than a “per frame” basis (all the frames captured for a particular person are applied to a single data set) ensures a machine learning model trained on the data is able to generalized over different people.

Above is described a first conditional variational autoencoder 20 to predict a 2D location for one or more missing feature points of an articulated object and a second conditional variational autoencoder 50 to predict depth data for each feature point of an articulated object. A result of having two decoupled models (one for the first conditional variational autoencoder 20 and another for the second conditional variational autoencoder 50) is that each model may be trained and optimized separately. This enables each model to be trained more efficiently or be better trained because, for example, the first model relates to a two-dimensional coordinate space for the feature points, while the second model relates to a three-dimensional coordinate space as each feature point further includes a depth aspect. The input, output, training, validation and/or test data for both models can be normalized separately, which simplifies the working of a system having both models separately. Predicting missing feature point locations in a first model and then predicting a depth value for the feature points in second model means that training of the second model is relatively simple as the training data for the second model will have a complete set of feature points for the articulated object. Both the first and second model may be trained separately and therefore replaced separately, so the system can be more easily optimized by replacing only one of the two models. Computational constraints are common on mobile and battery powered devices and using two smaller separate models (smaller in size and also reduced complexity) enables faster and more efficient computation. If there is limited training data for either or both models, training the models separately can give a better and more accurate prediction result.

The advantages of having a first conditional variational autoencoder 20 to predict a 2D location for one or more missing feature points of an articulated object and a second conditional variational autoencoder 50 to predict depth data for each feature point of the articulated object can be understood. A sole conditional variational autoencoder can be trained to receive 2D data corresponding to feature points of an articulated object with one or more of the feature points of the articulated object missing or identified as missing, and to predict three dimensional data for each feature point of the articulated object. The predicted three dimensional feature point data can be sampled, whereby the sampling may involve taking several samples, a single sample or a mean as a single sample. Training the sole conditional variational autoencoder would require 3D training data, similar to the training data for the second conditional variational autoencoder 50, but with one or more 3D feature points of the articulated object missing.

The first conditional variational autoencoder 20, second conditional variational autoencoder 50 and the sole conditional variational autoencoder as described above use a “single-shot” feature point prediction model, whereby feature point location data is predicted based on a single image or frame of a video. An alternative to a “single-shot” feature point prediction model is a tracking-based feature prediction model, whereby feature point location data is predicted based on a multiple images or frames of a video collected over time.

The “single-shot” feature point prediction model can have increased failure resistance. This is because the model does not rely on previous or future observations, so an instance where one or more feature points of an articulated object is not detected in a previous or following frame, a single-shot model will not fail, whereas a tracking-based feature prediction model may fail in an instance where one or more feature points of an articulated object were not detected in a previous or following frame. Should such a failure mode occur, a single-shot model is more likely to recover quicker and initially more accurately than a tracking-based model as the tracking-based model would lack location data from previous images or frames.

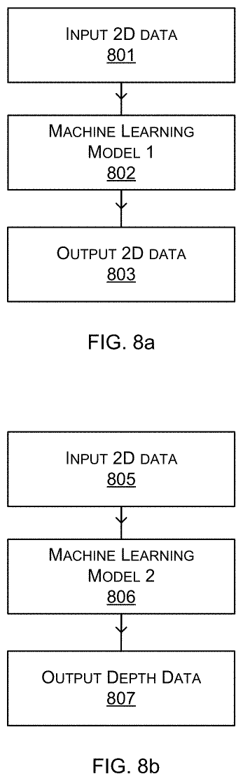

FIG. 8a is a flow diagram of a method for 2D location prediction for feature points an articulated object using a first generic machine learning model. An incomplete set of 2D location data points corresponding to feature points of an articulated object are input 801 into a first machine learning model 802, which is trained to predict a 2D location for each feature point of the articulated object that is missing. The predicted feature point is output 803 from the first model 802. The first machine learning model 802 is trained to receive data as illustrated in FIG. 3a and to predict data as illustrated in FIG. 3b. The input 801 and output data 803 is combined to provide data illustrated in FIG. 3c. The first machine learning model 802 is preferably a probabilistic machine learning model, which is any machine learning model that predicts a probability distribution over the variable being predicted, y. This is useful because, rather than the machine learning model providing a single prediction, the output 803 can be sampled to obtain multiple predicted values that can be used as input to a further machine learning model, e.g. the second machine learning model 806.

FIG. 8b is a flow diagram of a method for depth predation for feature points of an articulated object using to a second generic machine learning model 806. A set of 2D feature point locations of an articulated object are input 805 in to the second machine learning model 807, which has been trained to predict a depth (in a third dimension) for each of the 2D feature point locations of an articulated object. Predicted depth data is output 807 from the second machine learning model 806. The second machine learning model 806 is preferably a probabilistic machine learning model, which is any machine learning model which that predicts a probability distribution over the variable being predicted, d. This is useful because, rather than the machine learning model providing a single prediction, the output 807 can be sampled to obtain multiple predicted values that can be used either as an input to a further machine learning model or input into a further system.

The machine learning models 802, 806 either or both can be random decision forests or neural networks the same as or different to those already described. In one case, a conditional variational autoencoder is used and is found empirically to give good working results which are achieved in real time and are robust to occlusion as well as to rapid changes in the pose of the articulated object over time. A benefit of the conditional variational autoencoder model architecture is that it can be combined into a single model (as described above) which gives the benefit of end to end training, i.e. the whole model is trained as one unit, and, as a result, there is improved accuracy since the whole model is trained as one unit.

In FIG. 9, a back-projected articulated object 92 has feature points plotted 90 in 3D with predicted depth information used to calculate a position relative to a camera source 91. A skeleton is overlaid onto to the feature points to better illustrate how the obscured articulated body with visible features mapped in 2D, shown in FIG. 1a, has missing 2D feature point(s) 108 predicted and depth information for each 2D feature point predicted to provide a 3D location predicted relative to a camera device that took the original 2D image.

Alternatively, or in addition, the functionality described herein is performed, at least in part, by one or more hardware logic components. For example, and without limitation, illustrative types of hardware logic components that are optionally used include Field-Programmable Gate Arrays (FPGAs), Application-Specific Integrated Circuits (ASICs), Application-Specific Standard Products (ASSPs), System-on-a-chip systems (SOCs), Complex Programmable Logic Devices (CPLDs), Graphics Processing Units (GPUs).

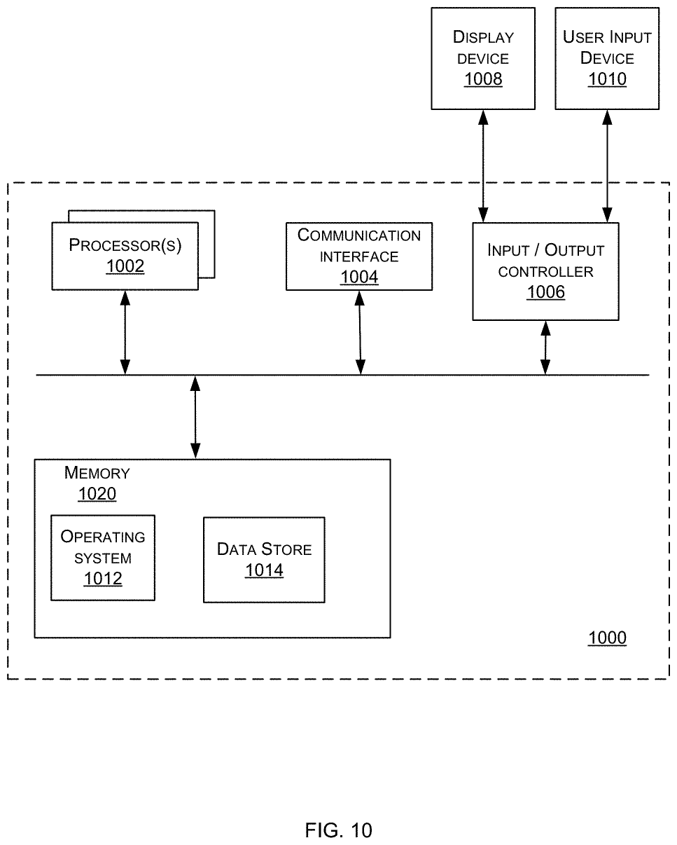

FIG. 10 illustrates various components of an exemplary computing-based device 1000 which are implemented as any form of a computing and/or electronic device, and in which embodiments of a training engine for training an articulated object feature prediction model or of a trained model for articulated object feature prediction are implemented in some examples.

Computing-based device 1000 comprises one or more processors 1002 which are microprocessors, controllers or any other suitable type of processors for processing computer executable instructions to control the operation of the device in order to train an articulated object feature prediction model and/or to use a trained articulated object feature prediction model at test time. In some examples, for example where a system on a chip architecture is used, the processors 1002 include one or more fixed function blocks (also referred to as accelerators) which implement a part of the method of FIG. 3, 4, 5, 7 or 8 in hardware (rather than software or firmware). Platform software comprising an operating system 1012 or any other suitable platform software is provided at the computing-based device to enable application software to be executed on the device.

The computer executable instructions are provided using any computer-readable media that is accessible by computing based device 1000. Computer-readable media includes, for example, computer storage media such as memory 1020 and communications media. Computer storage media, such as memory 1020, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1020) is shown within the computing-based device 1000 it will be appreciated that the storage is, in some examples, distributed or located remotely and accessed via a network or other communication link (e.g. using communication interface 1004).

The computing-based device 1000 also comprises an input/output controller 1006 configured to output display information to a display device 1008 which may be separate from or integral to the computing-based device 1000. The display information may provide a graphical user interface. The input/output controller 1006 is also configured to receive and process input from one or more devices, such as a user input device 1010 (e.g. a mouse, keyboard, camera, microphone or other sensor). In some examples the user input device 1010 detects voice input, user gestures or other user actions and provides a natural user interface (NUI). This user input may be used to start video sampling from a camera attached to the user input device 1010 and also start processing data related to feature points identified in the sample images. In an embodiment the display device 1008 also acts as the user input device 1010 if it is a touch sensitive display device. The input/output controller 1006 outputs data to devices other than the display device 1008 in some examples, e.g. a locally connected printing device (not shown in FIG. 10).

Any of the input/output controller 1006, display device 1008 and the user input device 1010 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (RGB) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

The computing-based device 1000 receives an RGB image input 401, RGB video stream 701 and skeleton data 702 via the user input device 1010. The processor(s) 1002 are arranged to process the received data to produce the training sets 442, 771, validation sets 452, 781 and test sets 462, 791 and store them in the data store 1014. A program running on the operating system 1012 trains the encoders and decoders of the conditional variational autoencoders 20, 50, sole variational autoencoder and/or first or second machine learning models 802, 806 before their validating and testing stages that are also performed by a program running on the operating system 1012.

The machine learning models, when trained, are run on a computing-based device 1000. Input 2D data 201 may be received via the user input device 1010 and stored in the data store 1014 prior to being operated on by the processor(s) 1002. The output of s first machine learning model and combined data 208 may be stored in the data store 1014 or held in another form of memory prior to being displayed by the display device 1008 or output in another manner. Alternatively or additionally, the combined data 208 is input into a second machine learning model and the output depth data 507 or the back-projected 3D location data is stored in memory or output via the display device 1008. Alternatively or additionally, the data may be output using another method.

The initial processing of a 2D image or frame of a video to extract visible 2D feature locations can be performed on the computing-based device 1000 using a machine vision algorithm run by a program and executed by the processor(s) 1002. The machine vision algorithm can be a convolutional neural network, conditional variational autoencoder or other algorithm trained or arranged to recognize features and extract a 2D location for the features from an image of an articulated object captured by an integrated or separate RGB camera, whereby the RGB image or video data is input to the computing-based device 1000 via the user input device 1010. Alternatively, the 2D location data and associated feature data are received from another device via the user input device 1010.

Alternatively or in addition to the other examples described herein, examples include any combination of the following:

A system to predict a location of a feature point of an articulated object, the system comprising a computing-based device configured to: receive a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing; input into a machine learning model the first set and the second set, wherein the machine learning model is trained to: receive a plurality of two-dimensional location data points each corresponding to a feature point location of an articulated object where one or more of the received two-dimensional location data of the articulated object are identified as missing, and predict two-dimensional location data for each feature point location that was identified as missing; and receive from the machine learning model predicted two-dimensional location data for each data point of the second set of data points.

The computing-based device is at least partially implemented using hardware logic selected from any one of more of: a field-programmable gate array, a program-specific integrated circuit, a program-specific standard product, a system-on-a-chip, a complex programmable logic device.

A computer-implemented method for predicting a location of a feature point of an articulated object comprising: receiving, at a processor, a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing; inputting into a first machine learning model the first set and the second set, wherein the machine learning model is trained to: receive a plurality of two-dimensional location data points each corresponding to a feature point location of an articulated object where one or more of the received two-dimensional location data of the articulated object are identified as missing, and predict two-dimensional location data for each feature point location that was identified as missing; and receiving from the first machine learning model predicted two-dimensional location data for each data point of the second set of data points.

The computer-implemented method further comprises combining the first set of the data points with the predicted second set of data points.

The computer-implemented method, wherein the first machine learning model is a probabilistic machine learning model, and the predicted two-dimensional location data comprises one of multiple samples of a distribution, a single sample of a distribution or a mean of a distribution as a single sample.

The computer-implemented method, wherein the machine learning model is a conditional variational autoencoder.

The computer-implemented method, wherein each of the received data points of the first set and second set is a labelled feature of an articulated object.

The computer-implemented method, wherein the plurality of two-dimensional location data points received at the processor correspond to a labeled image of the articulated object, and each label identifies a feature point of the articulated object.

The computer-implemented method, wherein at least one of the feature points corresponds to a joint location of the articulated object.

The computer-implemented method, wherein a Boolean value input into the first machine learning model for a single data point identifies whether the data point belongs to the first set or the second set.

The computer-implemented method, wherein a value of a received data point either being of a specific value or belonging within a specific range of values identifies whether the data point belongs to the first set or the second set.

The computer-implemented method further comprising: inputting into a second machine learning model the combined set of two-dimensional data, wherein the second machine learning model is a probabilistic machine learning model trained to receive a plurality of two-dimensional location data points and predict a distribution in a third dimension for each received two-dimensional location data point; sampling a third dimension value from each distribution; and outputting the third-dimensional sample.

The computer-implemented method, wherein the third-dimensional sample comprises one of multiple samples of the distribution, a single sample of the distribution or a mean of the distribution.

The computer-implemented method further comprising adding the third-dimensional sample for each two-dimensional data point to the respective two-dimensional data point to create a plurality of three-dimensional data points.

The computer-implemented method, wherein there is no feedback of location data from a previously output of the second machine learning model as an input into either the first machine learning model or the second machine learning model.

The computer-implemented method, wherein the combined set of two-dimensional data inputted comprises a plurality of samples for each two-dimensional location data point.

The computer-implemented method, wherein the machine learning model is a conditional variational autoencoder.

The computer-implemented method, wherein the machine learning component is stored in memory in one of a smartphone, a tablet computer a games console and a laptop computer.

One or more device-readable media with device-executable instructions that, when executed by a computing system, direct the computing system to perform for performing operations comprising the method steps of the computer-implemented method.

A system to predict a location of a feature point of an articulated object, the system comprising a computing-based device configured to: receive a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing; input into a first machine learning model the first set and the second set, wherein the machine learning model is trained to receive a plurality of two-dimensional location data points each corresponding to a feature point location of an articulated object where one or more of the received two-dimensional location data of the articulated object are identified as missing, and predict two-dimensional location data for each feature point location that was identified as missing; and receive from the first machine learning model predicted two-dimensional location data for each data point of the second set of data points; input into a second machine learning model the combined set of two-dimensional data, wherein the second machine learning model is a probabilistic machine learning model trained to receive a plurality of two-dimensional location data points and predict a distribution in a third-dimension for each received two-dimensional location data point; sample a third-dimension value from each distribution; and output the third-dimensional sample.

A computer-implemented method for predicting a three-dimensional location for a feature point of an articulated object comprising: inputting into a probabilistic machine learning model a set two-dimensional locations corresponding to a plurality of feature points, wherein the machine learning model is a probabilistic machine learning model trained to receive a plurality of two-dimensional location data points and predict a distribution in a third dimension for each received two-dimensional location data point; sampling a third dimension value from each distribution; and outputting the third-dimensional sample.

The computer-implemented method, wherein the third-dimensional sample is combined with the two-dimensional locations to provide a set of three dimension locations.

The examples illustrated and described herein as well as examples not specifically described herein but within the scope of aspects of the disclosure constitute exemplary means for predicting a location of a feature point of an articulated object. For example, the elements illustrated in FIG. 10, such as when encoded to perform the operations illustrated in FIGS. 2, 5, 8a and 8b, constitute exemplary means for predicting a location of a feature point of an articulated object.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

The configurations described above enable various methods for providing user input to a computer system. Some such methods are now described, by way of example, with continued reference to the above configurations. It will be understood, however, that the methods here described, and others within the scope of this disclosure, may be enabled by different configurations as well. The methods herein, which involve the observation of people in their daily lives, may and should be enacted with utmost respect for personal privacy. Accordingly, the methods presented herein are fully compatible with opt-in participation of the persons being observed. In embodiments where personal data is collected on a local system and transmitted to a remote system for processing, that data can be anonymized in a known manner. In other embodiments, personal data may be confined to a local system, and only non-personal, summary data transmitted to a remote system.

1. A system to predict a location of a feature point of an articulated object, the system comprising a computing-based device configured to:
receive a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing;
input into a machine learning model the first set and the second set, wherein the machine learning model is trained to:
receive a plurality of two-dimensional location data points each corresponding to a feature point location of an articulated object where one or more of the received two-dimensional location data of the articulated object are identified as missing, and
predict two-dimensional location data for each feature point location that was identified as missing; and
receive from the machine learning model predicted two-dimensional location data for each data point of the second set of data points.

2. The system according to claim 1, wherein the computing-based device being at least partially implemented using hardware logic selected from any one of more of: a field-programmable gate array, a program-specific integrated circuit, a program-specific standard product, a system-on-a-chip, a complex programmable logic device.

3. A computer-implemented method for predicting a location of a feature point of an articulated object comprising:
receiving, at a processor, a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing;
inputting into a first machine learning model the first set and the second set, wherein the machine learning model is trained to:
receive a plurality of two-dimensional location data points each corresponding to a feature point location of an articulated object where one or more of the received two-dimensional location data of the articulated object are identified as missing, and
predict two-dimensional location data for each feature point location that was identified as missing; and
receiving from the first machine learning model predicted two-dimensional location data for each data point of the second set of data points.

4. The computer-implemented method of claim 3 further comprising combining the first set of the data points with the predicted second set of data points.

5. The computer-implemented method of claim 3, wherein the first machine learning model is a probabilistic machine learning model, and the predicted two-dimensional location data comprises one of multiple samples of a distribution, a single sample of a distribution or a mean of a distribution as a single sample.

6. The computer-implemented method of claim 3, wherein the machine learning model is a conditional variational autoencoder.

7. The computer-implemented method of claim 3, wherein each of the received data points of the first set and second set is a labelled feature of an articulated object.

8. The computer-implemented method of claim 3, wherein the plurality of two-dimensional location data points received at the processor correspond to a labeled image of the articulated object, and each label identifies a feature point of the articulated object.

9. The computer-implemented method of claim 3, wherein at least one of the feature points corresponds to a joint location of the articulated object.

10. The computer-implemented method of claim 3, wherein a Boolean value input into the first machine learning model for a single data point identifies whether the data point belongs to the first set or the second set.

11. The computer-implemented method of claim 3, wherein a value of a received data point either being of a specific value or belonging within a specific range of values identifies whether the data point belongs to the first set or the second set.

12. The computer-implemented method of claim 3 further comprising:
inputting into a second machine learning model the combined set of two-dimensional data, wherein the second machine learning model is a probabilistic machine learning model trained to receive a plurality of two-dimensional location data points and predict a distribution in a third dimension for each received two-dimensional location data point;
sampling a third dimension value from each distribution; and
outputting the third-dimensional sample.

13. The computer-implemented method of claim 12, wherein the third-dimensional sample comprises one of multiple samples of the distribution, a single sample of the distribution or a mean of the distribution.

14. The computer-implemented method of claim 12 further comprising adding the third-dimensional sample for each two-dimensional data point to the respective two-dimensional data point to create a plurality of three-dimensional data points.

15. The computer-implemented method of claim 12, wherein there is no feedback of location data from a previously output of the second machine learning model as an input into either the first machine learning model of claim 3 or the second machine learning model of claim 12.

16. The computer-implemented method of claim 12, wherein the combined set of two-dimensional data inputted comprises a plurality of samples for each two-dimensional location data point.

17. The computer-implemented method of claim 12, wherein the machine learning model is a conditional variational autoencoder.

18. The computer-implemented method of claim 3, wherein the machine learning component is stored in memory in one of a smartphone, a tablet computer a games console and a laptop computer.

19. One or more device-readable media with device-executable instructions that, when executed by a computing system, direct the computing system to perform for performing operations comprising the method steps of claim 3.

20. A system to predict a location of a feature point of an articulated object, the system comprising a computing-based device configured to:
receive a plurality of data points comprising a first set of data points and a second set of one or more data points, wherein each data point of the first set comprises a two-dimensional location corresponding to a feature point of the articulated object, and each data point of the second set corresponds to a feature point of the articulated object without associated two-dimensional location data or wherein the two-dimensional location data is identified as missing;
input into a first machine learning model the first set and the second set, wherein the machine learning model is trained to receive a plurality of two-dimensional location data points each corresponding to a feature point location of an articulated object where one or more of the received two-dimensional location data of the articulated object are identified as missing, and predict two-dimensional location data for each feature point location that was identified as missing; and
receive from the first machine learning model predicted two-dimensional location data for each data point of the second set of data points;
input into a second machine learning model the combined set of two-dimensional data, wherein the second machine learning model is a probabilistic machine learning model trained to receive a plurality of two-dimensional location data points and predict a distribution in a third-dimension for each received two-dimensional location data point;
sample a third-dimension value from each distribution; and
output the third-dimensional sample.
